(19) United States
(12) Patent Application Publication
(10) Pub. No.: US 2026/0131724 A1
(43) Pub. Date: May 14, 2026

(54) VEHICLE AND CONTROL METHOD THEREOF

(71) Applicants: Hyundai Motor Company, Seoul (KR); Kia Corporation, Seoul (KR)

(72) Inventors: Jae Hyun KIM, Hwaseong-Si (KR); Sang Kyung SEO, Hwaseong-Si (KR)

(21) Appl. No.: 19/304,120

(22) Filed: Aug. 19, 2025

(30) Foreign Application Priority Data
Nov. 14, 2024 (KR) 10-2024-0162078

(51) Int. Cl. B60Q 3/80; B60H 1/00; B60Q 3/233; B60R 16/023; B60R 22/48; H05B 47/115

(52) U.S. Cl. CPC B60Q 3/80; B60H 1/00735; B60Q 3/233; B60R 16/0231; B60R 22/48; H05B 47/115; B60R 2022/4866

(57) ABSTRACT

A vehicle may comprise at least one interior lighting device of the vehicle, a sensor configured to detect seating of a user of the vehicle, a processor, and a memory storing at least one instruction. When executed by the processor communicating with the memory, the instruction is configured to cause the vehicle to obtain, via the sensor, boarding information about a user sitting in a seat of the vehicle, detect an event associated with controlling of the at least one interior lighting device, output a signal indicating the boarding information and indicating the event, and control, based on the signal, the at least one interior lighting device, wherein the at least one interior lighting device corresponds to the seat in which the user is sitting.

### CROSS-REFERENCE TO RELATED APPLICATION

This application claims the benefit of priority to Korean Patent Application No. 10-2024-0162078, filed in the Korean Intellectual Property Office on Nov. 14, 2024, the entire contents of which are incorporated herein by reference.

### TECHNICAL FIELD

Various examples of the present disclosure relate to relate to a technology for controlling the interior lighting of a vehicle.

### BACKGROUND

The matters described in this Background section are only for enhancement of understanding of the background of the disclosure, and should not be taken as acknowledgment that they correspond to prior art already known to those skilled in the art.

Technology for controlling the interior lighting of a vehicle is being developed in order to enhance convenience and safety. In particular, the interior lighting system of a vehicle plays an important role in controlling lighting according to a boarding position of a passenger or transmitting various types of warning information to a driver and the passenger beyond a simple lighting function.

For example, an interior mood lamp mounted in a vehicle may improve a user's emotional experience and provide visual feedback by changing to a specific color or pattern in conjunction with a situation or event in the vehicle. This may provide an intuitive warning according to a situation while driving, and also support so that a passenger in the vehicle has a safe and comfortable experience.

However, current vehicle lighting control technology may not satisfy both user experience and safety, and expanding the control of a mood lamp according to various scenarios is considered.

### SUMMARY

The present disclosure has been made to solve the aforementioned problems, and is directed to providing a technology for controlling an interior lighting device such as a mood lamp according to a boarding position of a passenger and various event states in a vehicle.

The problems to be solved by the present disclosure are not limited to the problems mentioned above, and other problems not mentioned can be clearly understood by those skilled in the art from the description below.

According to the present disclosure, a vehicle may comprise at least one interior lighting device of the vehicle, a sensor configured to detect seating of a user of the vehicle, a processor, and a memory storing at least one instruction that, when executed by the processor communicating with the memory, is configured to cause the vehicle to, obtain, via the sensor, boarding information about a user sitting in a seat of the vehicle, detect an event associated with controlling of the at least one interior lighting device, output a signal indicating the boarding information and indicating the event, and control, based on the signal, the at least one interior lighting device, wherein the at least one interior lighting device corresponds to the seat in which the user is sitting.

The vehicle, wherein the event may comprise a call event of a user terminal communicatively connected to the vehicle, and wherein the at least one instruction, when executed by the processor communicating with the memory, is configured to cause the vehicle to control, based on the call event, the at least one interior lighting device. The vehicle, wherein the at least one instruction, when executed by the processor communicating with the memory, is configured to cause the apparatus to control the at least one interior lighting device differently based on at least one of, a call connection waiting state of the user terminal, a call connection state of the user terminal, or a call termination state of the user terminal.

The vehicle, wherein the event may comprise an event of controlling an air conditioning system of the vehicle, and wherein the at least one instruction, when executed by the processor communicating with the memory, is configured to cause the vehicle to control, based on the controlling of the air conditioning system, the at least one interior lighting device, wherein the at least one interior lighting device is configured to illuminate a location of the seat. The vehicle, wherein the at least one instruction, when executed by the processor communicating with the memory, is configured to cause the vehicle to control, based on an output of the air conditioning system, an output of the at least one interior lighting device differently.

The vehicle, wherein the at least one instruction, when executed by the processor communicating with the memory, is configured to cause the vehicle to, identify a seat adjacent to a location at which a user input for the controlling of the air conditioning system is received, and control, based on the identified seat, the at least one interior lighting device. The vehicle, wherein the at least one instruction, when executed by the processor communicating with the memory, is configured to cause the vehicle to, measure, based on the controlling of the air conditioning system, an interior temperature of the vehicle, measure a body temperature of the user of the vehicle, and control, based on a temperature difference between the interior temperature and the body temperature of the user, an output of the at least one interior lighting device.

The vehicle, wherein the at least one instruction, when executed by the processor communicating with the memory, is configured to cause the vehicle to control, based on a warning event associated with a driving of the vehicle, the at least one interior lighting device corresponding to the seat. The vehicle, wherein the at least one instruction, when executed by the processor communicating with the memory, is configured to cause the vehicle to, identify, based on the warning event being associated with a detected external object, a seat in a direction associated with the detected external object, and control, based on the identified seat, the at least one interior lighting device.

The vehicle, wherein the event may comprise a warning event associated with fastening of a seat belt of the vehicle, and wherein the at least one instruction, when executed by the processor communicating with the memory, is configured to cause the vehicle to control, based on the warning event associated with fastening of the seat belt, the at least one interior lighting device corresponding to the seat. The vehicle, wherein the at least one instruction, when executed by the processor communicating with the memory, is configured to cause the vehicle to, identify a seat corresponding to the warning event associated with fastening of the seat belt, and control, based on the identified seat, the at least one interior lighting device, wherein the at least one interior lighting device corresponds to the identified seat.

According to the present disclosure, a method performed by a vehicle, the method may comprise obtaining, via a sensor of the vehicle, boarding information about a user sitting in a seat of the vehicle, detecting an event associated with controlling an interior lighting device of the vehicle, outputting a signal indicating the boarding information and indicating the event, and controlling, based on the signal, the interior lighting device, wherein the interior lighting device corresponds to the seat in which the user is sitting.

The method, wherein the event may comprise a call event of a user terminal communicatively connected to the vehicle, and wherein the controlling of the interior lighting device may comprise controlling, based on the call event, the interior lighting device. The method, wherein the controlling of the interior lighting device may comprise controlling the interior lighting device differently based on at least one of, a call connection waiting state of the user terminal, a call connection state of the user terminal, or a call termination state of the user terminal.

The method, wherein the event may comprise an event of controlling an air conditioning system of the vehicle, and wherein the controlling of the interior lighting device may comprise controlling, based on the event of controlling the air conditioning system of the vehicle, the interior lighting device, wherein the interior lighting device is configured to illuminate a location of the seat. The method, wherein the controlling of the interior lighting device may comprise controlling, based on an output of the air conditioning system, an output of the interior lighting device differently. The method, wherein the controlling of the interior lighting device may comprise identifying a seat adjacent to a location at which a user input for the controlling of the air conditioning system is received, and controlling, based on the identified seat, the interior lighting device, wherein the interior lighting device corresponds to the identified seat so that the interior lighting device outputs light over the identified seat. The method may further comprise measuring, based on the controlling of the air conditioning system, an interior temperature of the vehicle, measuring a body temperature of the user of the vehicle, and controlling, based on a temperature difference between the interior temperature and the body temperature of the user, an output of the interior lighting device.

According to the present disclosure, a method performed by a vehicle, the method may comprise obtaining, from a sensor of the vehicle, sensor data indicating a presence of a user within the vehicle, identifying, based on the obtained sensor data, a seat of the vehicle in which the user is seated, during an autonomous driving operation of the vehicle, identify an event associated with an object, output a signal indicating a location of the identified seat and indicating the event, and controlling, based on the signal, an interior lighting device of the vehicle that is configured to illuminate the location of the identified seat.

The method, wherein the controlling of the interior lighting device may comprise adjusting, based on a type of event detected in the vehicle, a lighting output of the interior lighting device, wherein the lighting output of the interior lighting device indicates a visual indication associated with the object, and wherein the object may comprise at least one of an internal object (e.g., a cell phone, an air conditioner, etc.) placed in the vehicle or an external object (e.g., a speed limit sign, a traffic light, a warning signal, another vehicle, etc.) external to the vehicle.

### BRIEF DESCRIPTION OF THE DRAWINGS

The above and other objects, features and advantages of the present disclosure will become more apparent to those of ordinary skill in the art by describing exemplary examples thereof in detail with reference to the accompanying drawings, in which:

FIG. 1 shows an exemplary configuration diagram of a vehicle according to an example;

FIG. 2 shows an exemplary operation of controlling an interior lighting device according to an example;

FIG. 3 and FIG. 4 shows exemplary diagrams of the operation of controlling the interior lighting device according to the example;

FIG. 5 and FIG. 6 shows an exemplary operation of controlling the interior lighting device in conjunction with a call event according to an example;

FIG. 7A, FIG. 7B, and 7C shows exemplary diagrams of the operation of controlling the interior lighting device in conjunction with the call event according to the example;

FIG. 8, FIG. 9, and FIG. 10 shows an exemplary operation of controlling the interior lighting device in conjunction with an air conditioning system control event according to an example;

FIG. 11A, FIG. 11B, and FIG. 11C shows exemplary diagrams of the operation of controlling the interior lighting device in conjunction with the air conditioning system control event according to the example;

FIG. 12 shows an exemplary operation of controlling the interior lighting device in conjunction with a driving system-related warning event according to an example;

FIG. 13 shows an exemplary operation of controlling the interior lighting device in conjunction with the driving system-related warning event according to the example;

FIG. 14 shows an exemplary operation of controlling the interior lighting device in conjunction with a seat belt fastening event according to an example; and

FIG. 15 shows an exemplary operation of controlling the interior lighting device in conjunction with the seat belt fastening event according to the example.

FIG. 16 shows an example computing system (e.g., a computing device of a vehicle or any other apparatus).

### DETAILED DESCRIPTION

Hereinafter, preferred examples of the present disclosure will be described in detail with reference to the accompanying drawings.

However, the technical idea of the present disclosure is not limited to some of the examples that will be described, but may be implemented in various different forms, and one or more of the components in the examples may be selectively combined or substituted and used within the scope of the technical idea of the present disclosure.

Further, terms (including technical and scientific terms) used in the examples of the present disclosure may be construed as having a meaning that can be generally understood by those skilled in the art to which the present disclosure belongs, unless explicitly and specifically defined and described, and meanings of terms that are commonly used, such as terms defined in a dictionary, may be construed in consideration of contextual meaning of the related art.

In addition, the terms used in the examples of the present disclosure are intended to describe the examples and are not intended to limit the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, terms such as first, second, A, B, (a), and (b) may be used to describe components in the examples of the present disclosure.

These terms are only intended to distinguish the component from other components, and do not limit the nature, order, or sequence of the component.

When a component is described as being “connected,” “coupled,” or “joined” to another component, this may include not only a case where the component is directly connected, coupled, or joined to the other component, but also a case where the component is “connected,” “coupled,” or “joined” to the other component by still another component between the component and the other component.

Further, when one component is described as being formed or disposed “on or under” another component, the term “on or under” includes not only a case in which two components are in direct contact with each other, but also a case in which one or more other components are formed or disposed between the two components. In addition, when the term “on or under” is expressed, this may mean not only an upward direction but also a downward direction with respect to one component.

In various flowcharts of the present disclosure, at least some of steps may be omitted or the order of each step may be changed, and at least some of the various examples of the present disclosure may be performed at a specific point in time in each step of the flowchart. The various flowcharts of the present disclosure may be performed by at least one of a control device 100, a processor 130, and a vehicle 10.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of controlling an interior lighting device of a vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of controlling an interior lighting device of a vehicle) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of controlling an interior lighting device of a vehicle) described herein.

Minimum risk maneuver (MRM) operation(s) may also be controlled, for example, based on one or more features (e.g., features of controlling an interior lighting device of a vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of controlling an interior lighting device of a vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of controlling an interior lighting device of a vehicle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features of controlling an interior lighting device of a vehicle) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

Hereinafter, the examples will be described in detail with reference to the accompanying drawings, and the same or corresponding components will be denoted by the same reference numbers regardless of drawing symbols, and redundant descriptions thereof will be omitted.

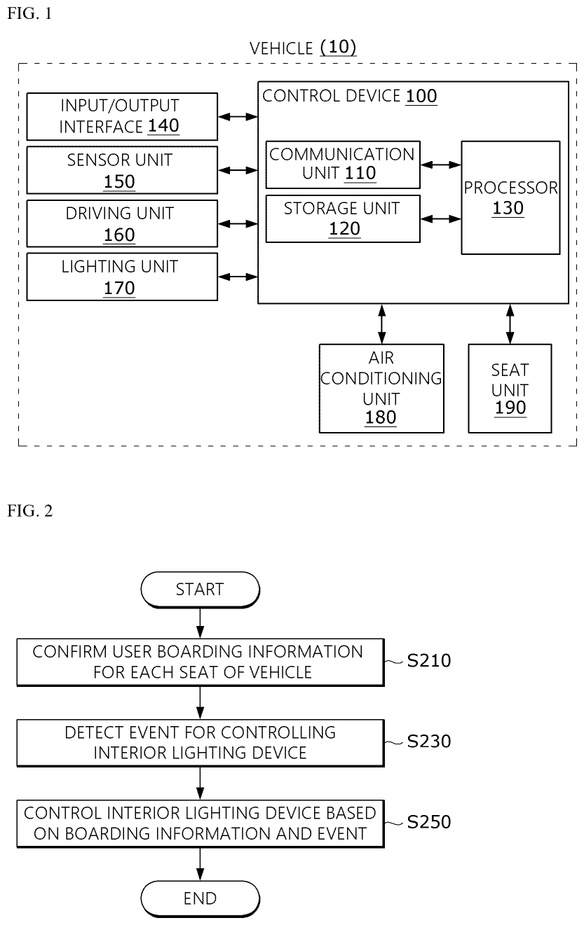

FIG. 1 shows an exemplary configuration diagram of a vehicle according to an example.

The vehicle 10 may include the control device 100, a communication unit 110, a storage unit 120, the processor 130, an input/output interface 140, a sensor unit 150, the driving unit 160, a lighting unit 170, an air conditioning unit 180, and a seat unit 190. Each of these components of FIG. 1 may be implemented inside the vehicle.

The control device 100 is an electronic device or program that controls at least one interior lighting device of the vehicle. The control device 100 may be formed integrally with internal components of the vehicle, or may be implemented as a separate device and connected to the internal components of the vehicle by a separate connection means (e.g., a wired harness, a CAN bus, or a wireless communication link, etc.). The control device 100 is illustrated as including the communication unit 110, the storage unit 120, and the processor 130, but may be configured to further include additional components (e.g., a vehicle status monitor, a user interface controller, or a thermal management controller, etc.) of the vehicle 10.

The communication unit 110 may perform communication with at least some components included in the vehicle 10, a user terminal, another vehicle, or an external server. The communication unit 110 may perform short range communication (e.g., Bluetooth® or Wi-Fi Direct™), GPS signal reception, vehicle-to-everything (V2X) communication (e.g., V2V, V2I, or V2P), optical communication (e.g., infrared or Li-Fi), broadcast transmission and reception (e.g., digital radio or DMB), and intelligent transport systems (ITS) communication functions.

The communication unit 110 may support short-range communication by using at least one of Bluetooth®, radio frequency identification (RFID), infrared data association (IrDA), ultra wideband (UWB), ZigBee, near field communication (NFC), wireless-fidelity (Wi-Fi), Wi-Fi direct, or wireless universal serial bus (wireless USB) technologies. In addition, the communication unit 110 may include a mobile communication module using a mobile communication network (e.g., 4G LTE, 5G NR, or future-generation cellular systems, etc.) and a wireless Internet module for wireless Internet access (e.g., Wi-Fi or hotspot tethering, etc.).

According to an example, the communication unit 110 may be designed to communicate with the sensor unit 150, the driving unit 160, the lighting unit 170, the air conditioning unit 180, and the seat unit 190 implemented inside the vehicle 10, and to exchange control signals for an interior lighting system, an air conditioning system, a seat control system, or other vehicle subsystems (e.g., infotainment or safety alert systems, etc.). For example, the communication unit 110 may be configured to connect to the user terminal and transmit a status signal (e.g., call initiation, message reception, application notification, or alarm trigger, etc.) of the user terminal to the control device 100 when a call event occurs during driving, so that a status of the interior lighting device (a corresponding lighting effect such as a flashing lamp, color shift, or brightness change, etc.) can be automatically controlled.

The storage unit 120 may be included inside the processor 130 or the control device 100, or may be a separate memory. The storage unit 120 may be configured as a combination of a non-volatile memory such as a hard disk drive, a flash memory, an electrically erasable programmable read-only memory (EEPROM), a static random access memory (SRAM), a ferroelectric RAM (FRAM), a phase-change RAM (PRAM), or a magnetic RAM (MRAM), and/or a volatile memory such as a dynamic random access memory (DRAM), a synchronous dynamic random access memory (SDRAM), or a double rate-SDRAM (DDR-SDRAM).

According to an example, the storage unit 120 stores vehicle interior lighting settings, air conditioning system control settings, user preference information, and the like to perform support so that the user can easily restore or call previously set customized functions. For example, the storage unit 120 can store lighting profiles (e.g., preferred color schemes, brightness levels, animation patterns, or seat-specific lighting zones, etc.) of a selected mood lamp (for example, the interior lighting device) when a specific event occurs.

The processor 130 can be electrically connected to the communication unit 110, the storage unit 120, the input/output interface 140, the sensor unit 150, the driving unit 160, the lighting unit 170, the air conditioning unit 180, the seat unit 190, and various internal components of the vehicle 10, can electrically control each component, and can be an electric circuit that executes software commands, thereby performing various data processing and calculations (e.g., sensor data fusion, event detection, or lighting pattern generation, etc.), which will be described below.

The processor 130 can process signals transmitted between the respective components of the vehicle 10 and perform overall control so that each component can perform its function normally. The processor 130 may be implemented in the form of hardware, in the form of software, or in the form of a combination of hardware and software (e.g., an embedded system-on-chip, a vehicle ECU, or a microcontroller with firmware, etc.).

The input/output interface 140 may include an input means for receiving a control command from a user, and an output means for outputting, for example, an operation status and results of the control device 100. Here, the input means may include physical keys (e.g., physical buttons, rotary knobs, or touchpads, etc.), and soft keys implemented on a touch display.

The output means may include a display, and may further include a voice output means such as a speaker, and a haptic module that generates vibrations. In this case, when a touch sensor such as a touch film, a touch sheet, or a touch pad is provided in the display, the display may operate as a touch screen, and the input means and the output means may be implemented in an integrated form.

The input/output interface 140 may be implemented as user-accessible components (e.g., physical buttons, a display, a head-up display (HUD), a cluster, an audio video navigation (AVN), a human machine interface (HMI), a user setting menu (USM), etc.). Also, the display may be included in a rearview mirror or a side mirror.

For example, the user may request a display related to control of the interior lighting device through a physical button of a cluster or a display of the AVN serving as the input means. In addition, the vehicle 10 may receive an input or output a screen through a display of a console located in a second row or a third row of the vehicle, or a display of an application implemented in a user terminal (e.g., a smartphone app, a tablet-based remote controller, or a built-in rear-seat entertainment screen, etc.).

The sensor unit 150 may include at least one or more of a radio detection and ranging (RADAR), a light imaging detection and ranging (LIDAR), an ultrasonic sensor, a fingerprint recognition sensor, a retina recognition sensor, an iris recognition sensor, a camera (e.g., an internal camera or a thermal imaging camera), an infrared sensor, a heart rate sensor, a light sensor, a pressure sensor, a seat sensor, and a motion sensor, etc. The sensor unit 150 may collect biometric information such as a passenger's facial expression, heart rate, blood flow, and body temperature.

According to an example, the sensor unit 150 may detect whether a passenger is sitting in each seat inside the vehicle. The sensor unit 150 may ascertain various conditions inside the vehicle and provides data to the control device 100, thereby enabling control of operations of the interior lighting devices, air conditioning system, and the like of the vehicle based on passenger-related information (e.g., occupancy status, posture, movement, or biometric condition, etc.). For example, the sensor unit 150 may detect a seating status of a driver seat and a passenger seat and provide information to the control device 100 so that the interior lighting device (e.g., a seat-specific mood lamp, floor lighting, or overhead illumination, etc.) associated with the seat is activated when the specific event occurs.

The driving unit 160 may include various driving devices inside the vehicle 10 to control the functions of the vehicle. For example, the driving unit 160 may include actuators and motors (e.g., a window motor, a seat motor, a fan motor of the air conditioning system, a sunroof motor, or a mirror adjustment motor, etc.), and may be designed to receive an operation signal for each device to perform a corresponding function. The driving unit 160 may be configured to perform an operation such as adjusting the seat according to a specific situation through a control command from the control device 100.

The lighting unit 170 may include at least one light source that can illuminate the interior of the vehicle with light. For example, the lighting unit 170 may include illumination devices (e.g., a sun visor lamp, a cluster lamp, a display lamp, a button lamp, a mood lamp, a reading lamp, or a mood lamp, etc.). In this case, it is preferable for at least one of brightness and color to be variable in individual lighting elements constituting the lighting unit 170. When brightness or color is fixed, the lighting elements may participate in changing an interior lighting environment through on/off control.

In various examples of the present disclosure, the lighting unit 170 may include one or more interior lighting devices. For example, the lighting unit 170 may include various lighting devices such as a mood lamp, a reading light, a cluster lamp, and a sun visor lamp, or other types of ambient, accent, or courtesy lighting (e.g., footwell lighting, door trim lighting, overhead dome lights, or center console illumination, etc.), and each lighting device may have a configuration capable of adjusting parameters such as a color, brightness, a blinking cycle, and the like according to a specific event or user setting. The lighting unit 170 may receive a command from the control device 100 and activate or adjust the interior lighting according to a situation to provide visual feedback to the user.

The air conditioning unit 180 may include an air conditioning system (e.g., a heating, ventilation, and air conditioning (HVAC)) (heating, ventilation, and air conditioning; HVAC) module. The air conditioning unit 180 may operate the air conditioning system of the vehicle 10 according to a control request received from the control device 100.

The air conditioning unit 180 may operate or adjust an air conditioner, a heater, a ventilation device, and the like based on information such as interior and exterior temperatures, user preference settings (e.g., desired cabin temperature, airflow direction, or fan speed), and interior air quality (e.g., humidity, particulate level, or CO₂ concentration, etc.) to maintain an interior environment. In addition, the air conditioning unit 180 may perform cooling or heating when a specific event occurs, or provide customized air conditioning to individual seat areas (e.g., driver seat, front passenger seat, or second-row side seats, etc.) depending on the positions and conditions of passengers who board the vehicle.

The seat unit 190 may operate a power seat function (e.g., forward/backward movement, tilt adjustment, or lumbar support adjustment), a massage function, a swivel function, a recliner function, a heating wire, a ventilation function, and the like of the seats included in the vehicle 10. The seat unit 190 may control at least some of the seats of the vehicle 10 and functions of the seats according to a control request received from the control device 100.

Hereinafter, the content for control of the interior lighting device of the vehicle will be described in detail with reference to FIGS. 2 to 15.

FIG. 2 shows an exemplary operation of controlling the interior lighting device according to an example.

The control device 100 may confirm user boarding information for each seat of the vehicle (S210).

Specifically, the control device 100 may ascertain whether there is a user sitting in each seat through data collected from the seat sensor, the camera, the ultrasonic sensor, or other types of presence-detection sensors (e.g., pressure sensors or infrared sensors, etc.) of the sensor unit 150.

The control device 100 may detect an event for controlling the interior lighting device (S230).

According to an example of the present disclosure, the control device 100 may control the interior lighting device based on boarding information according to various scenarios. The control of the interior lighting device according to such scenarios includes, for example, powering on/off of the interior lighting device according to the intention of the user, adjusting the brightness of the lighting, and changing the color.

In addition, the control device 100 may receive various events occurring in the vehicle, such as incoming calls, a vehicle warning signals, and operation of the air conditioning system, from the sensor unit 150 or the communication unit 110 and link the events with the interior lighting device.

The control device 100 may control the interior lighting device based on the boarding information and the event (S250).

Specifically, the control device 100 may adjust the interior lighting device around the seat according to the detected position and condition (e.g., presence, posture, or activity state, etc.) of the user sitting in each seat using boarding information collected from the sensor unit 150. For example, the control device 100 may activate only the mood lamp around the seat in which the user is sitting to reduce unnecessary lighting, and intuitively indicate a seating position by setting a specific color or pattern (e.g., blue for occupied, red for warning, or green for idle, etc.).

For example, when the user boards the vehicle, the control device may confirm whether the user is sitting based on data from the sensor unit 150 and automatically turn on the interior lighting device corresponding to the seat.

In addition, the control device 100 may control the interior lighting device depending on event detection according to various scenarios through the examples that will be disclosed through respective drawings below. For example, the control device 100 may confirm the boarding information for each seat and then adjust the interior lighting device adjacent to the seat depending on the detected event (e.g., a call reception, air conditioning adjustment, seat belt status, or vehicle proximity warning, etc.) according to the various scenarios.

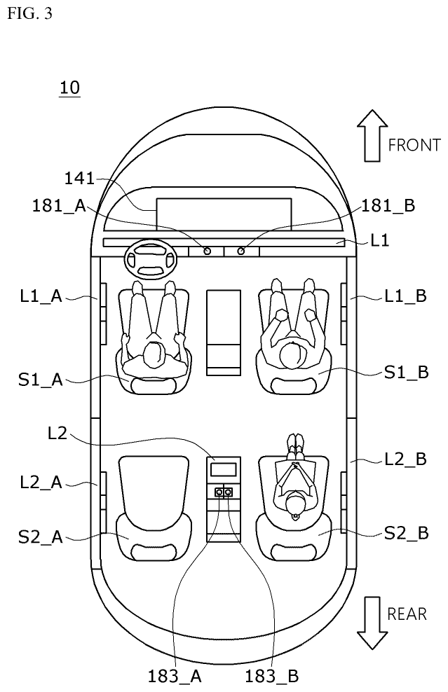

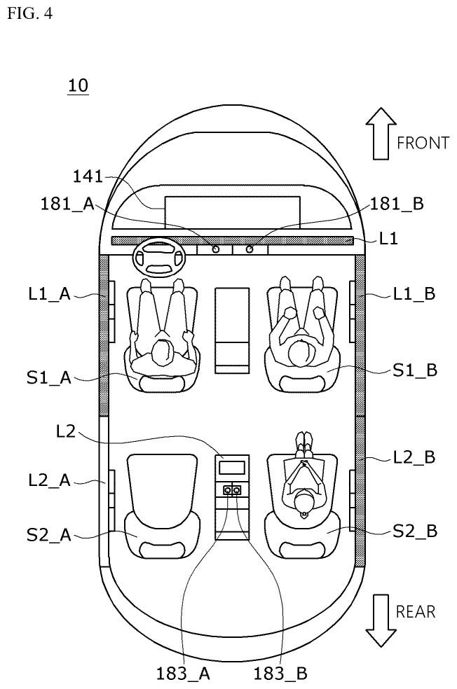

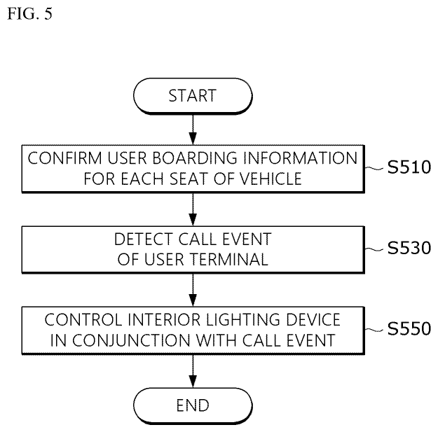

FIGS. 3 and 4 shows exemplary diagrams of the operation of controlling the interior lighting device according to the example.

Referring to FIG. 3, the vehicle 10 may include a front display 141, a first-row common lighting device L1, a second-row common lighting device L2, a first air conditioning button 181_A and a first interior lighting device L1_A corresponding to a first-row driver seat S1_A, a second air conditioning button 181_B and a second interior lighting device L1_B corresponding to a first-row passenger seat S1_B, a third air conditioning button 183_A and a third interior lighting device L2_A corresponding to a second-row driver seat side seat S2_A, and a fourth air conditioning button 183_B and a fourth interior lighting device L2_B corresponding to a second-row passenger seat side seat S2_B (e.g., a left or right outboard seat in the second row of a three-row vehicle, etc.).

In addition, the vehicle 10 may include a vehicle common lighting device that outputs light across all seats of the vehicle 10, in addition to the first-row common lighting device L1 and the second-row common lighting device L2. The interior lighting devices L1, L2, L1_A, L1_B, L2_A, and L2_B shown in FIG. 3 are exemplary, and their number, position, or form may vary depending on the design of the vehicle (e.g., SUV, sedan, or minivan, etc.).

FIG. 4 illustrates the control of the interior lighting device corresponding to a seat in which a user is sitting if an event for controlling the interior lighting device is detected. Specific examples of the event for controlling an interior lighting device will be described later with reference to the drawings below.

In the vehicle 10 of FIG. 4, the control device 100 may confirm boarding information indicating a state in which a total of three users are sitting in the first-row seats S1_A and S1_B and the passenger seat side seat S2_B among the second-row seats. For example, the control device 100 may confirm whether the user is sitting through the seat sensor of the sensor unit 150 (e.g., by detecting pressure, motion, or biometric data at the seat location, etc.).

The control device 100 may control the lighting unit 170 so that the interior lighting devices L1_A, L1_B, and L2_B corresponding to the seats S1_A, S1_B, and S2_B in which the users are sitting output light according to a specific event (e.g., mood lamp control in response to entering a rest mode or starting media playback, etc.). In this case, since the users are sitting in both seats S1_A and S1_B of the first row, the first-row common lighting device L1 may also output light. However, the present disclosure is not limited thereto, and the first-row common lighting device L1 and the second-row common lighting device L2 may be controlled independently (e.g., based on occupancy or contextual needs).

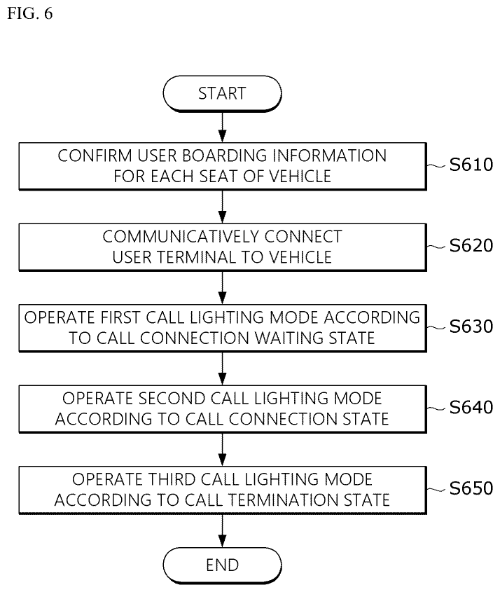

FIGS. 5 and 6 shows an exemplary operation of controlling the interior lighting device in conjunction with a call event according to an example.

The control device 100 may confirm the user boarding information for each seat of the vehicle 10 (S510) and detect the occurrence of a call event of the user terminal (S530).

Specifically, the control device 100 may detect a call reception signal in a state in which the control device 100 is connected to the user terminal through the communication unit 110. For example, when a call comes in or the call starts on the user terminal, the communication unit 110 may transmit the corresponding signal to the control device 100 so that the control device 100 may recognize a call event.

The control device 100 may control the interior lighting device in conjunction with the call event (S550).

Specifically, the control device 100 may set a different color and pattern of the interior lighting device depending on the state of the call, such as a call connection waiting, call in progress, or call end state (e.g., blue for incoming, green during a call, red after disconnection, etc.).

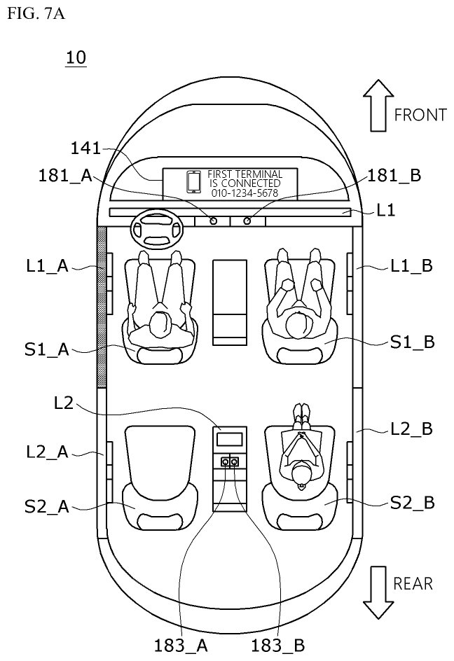

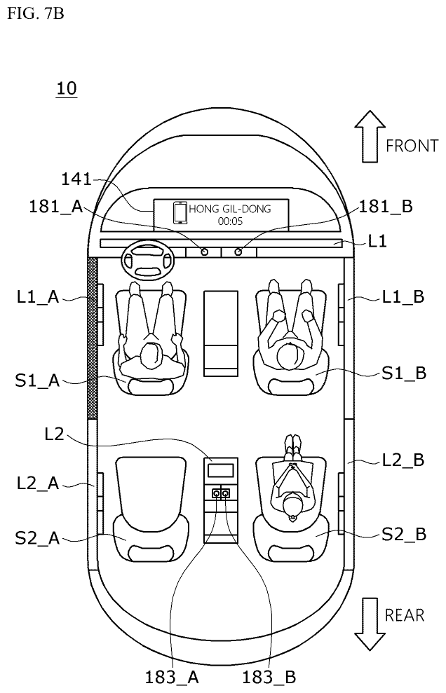

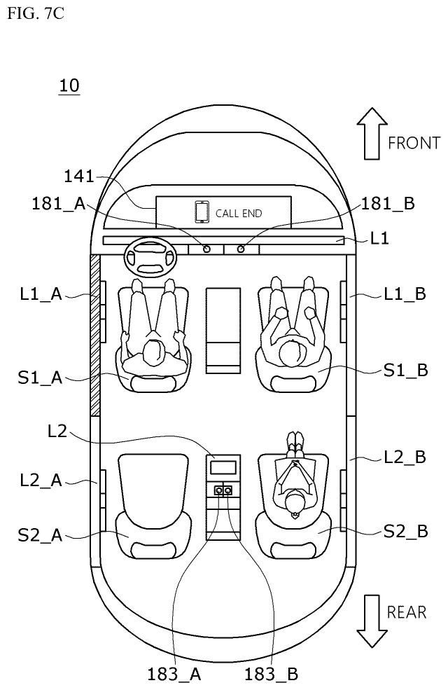

FIG. 6 shows specific content for control of the interior lighting device in conjunction with the call event. For the description of FIG. 6, reference will be made to FIGS. 7A to 7C. FIGS. 7A to 7C shows exemplary diagrams of the operation of controlling the interior lighting device in conjunction with the call event according to an example.

The control device 100 may confirm the user boarding information for each seat of the vehicle (S610) and establish a communication connection between the user terminal and the vehicle (e.g., via Bluetooth®, Wi-Fi®, or a cellular network interface) (S620).

For example, in FIG. 7A, the control device 100 may establish a communication connection between the vehicle 10 and a first terminal (e.g., a smartphone or wearable device) through the communication unit 110. The first terminal may be, for example, a smartphone (not illustrated) held by a user sitting in the first-row driver seat S1_A.

Next, the control device 100 may operate a first call lighting mode according to a call connection waiting state (S630).

The call connection waiting state may refer to a state in which an incoming call signal is received by the user terminal but no response is made. In other words, the call connection waiting state indicates that a call is coming in from the other party but has not been answered yet. For example, in FIG. 7A, a state in which the first terminal and the vehicle 10 are connected may be displayed on the front display 141, and a situation in which a call is received from the other party terminal (010-1234-5678) may be output as an alert or on-screen notification.

In FIG. 7A, the control device 100 may confirm the first-row driver seat S1_A where the user terminal is located, and cause the first interior lighting device L1_A to output light in a first form (e.g., a specific color, brightness level, or blinking pattern) according to the first call lighting mode. According to various examples, the first form may mean a state in which the first interior lighting device L1_A outputs light in a first color (for example, blue) or the first interior lighting device L1_A blinks in a first cycle, or a state in which the first interior lighting device L1_A outputs light in a first brightness (e.g., dim or pulsed illumination to avoid driver distraction).

Next, the control device 100 may operate a second call lighting mode (e.g., setting a steady green glow or activating a pulsing effect) according to the call connection state (S640).

The call connection state may refer to a state in which the user inputs a response to a call connection on the terminal and a voice signal is transmitted or received between the user and the other party. For example, in FIG. 7B, a current calling time (00:05) when the call connection is established is displayed on the front display 141.

In FIG. 7B, the control device 100 may cause the first interior lighting device L1_A to output light in a second form (e.g., steady green illumination or a gentle pulsing effect) according to the second call lighting mode. According to various examples, the second form may mean a state in which the first interior lighting device L1_A outputs light in a color (for example, green) different from the first color, or the first interior lighting device L1_A blinks in a second cycle different from the first cycle, or a state in which the first interior lighting device L1_A outputs light in a second brightness different from the first brightness (e.g., solid green light with medium brightness to indicate an active call).

Next, the control device 100 may operate a third call lighting mode according to a call termination state (S650). For example, in FIG. 7C, content indicating that the call connection has been terminated is displayed on the front display 141 (e.g., a “Call Ended” message or call duration summary).

In FIG. 7C, the control device 100 may cause the first interior lighting device L1_A to output light in a third form (e.g., a brief red blink, a fade-out effect, or a color transition) according to the third call lighting mode. According to various examples, the third form may mean a state in which the first interior lighting device L1_A outputs light in a color (for example, red) different from the first color and the second color, or the first interior lighting device L1_A blinks in a third cycle different from the first cycle and the second cycle, or a state in which the first interior lighting device L1_A outputs light in a third brightness different from the first brightness and the second brightness (e.g., short-duration red pulse to signify call has ended).

As described above, the control device 100 may control the interior lighting device differently depending on whether the user terminal is in a call connection waiting state, a call connection state, or a call termination state. In this case, the controlled interior lighting device may be the interior lighting device corresponding to the seat in which the user is sitting (e.g., to localize visual feedback and minimize distraction to other occupants).

This allows the control device 100 to intuitively recognize a call status of a specific user without distracting the attention of the driver while driving by providing visual feedback according to the call status (e.g., allowing peripheral awareness of call changes without checking the display).

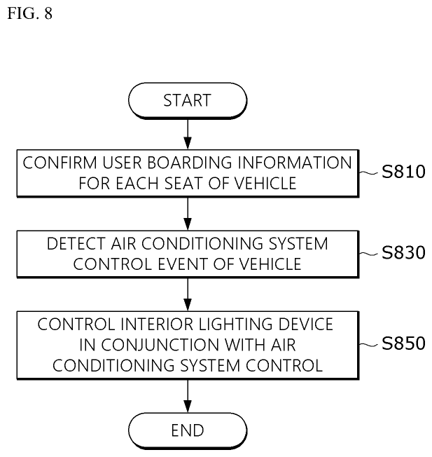

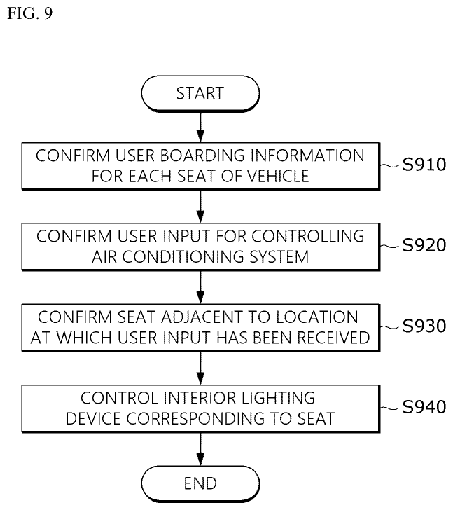

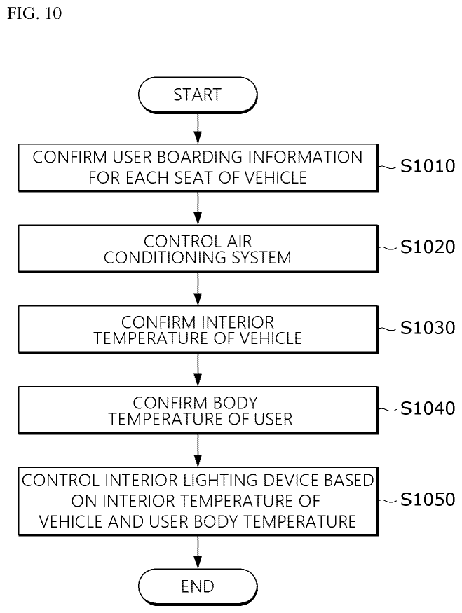

FIGS. 8 to 10 shows an exemplary operation of controlling the interior lighting device in conjunction with an air conditioning system control event according to an example.

The control device 100 may confirm the user boarding information for each seat of the vehicle 10 (S810) and detect the air conditioning system control event of the vehicle 10 (e.g., activation of cooling or heating, fan speed adjustment, or user input at an HVAC control interface) (S830).

For example, the control device 100 may receive air conditioning system operation status information provided by the air conditioning unit 180 and detect a point in time when the air conditioner or the heater is operated or when a temperature setting is changed by the user or an automatic system.

The control device 100 may control the interior lighting device in conjunction with the air conditioning system control (S850) to provide responsive visual feedback to the relevant seat area.

For example, the control device 100 may detect changes in operating conditions of the air conditioning system when the operating conditions (e.g., fan speed or temperature settings) of the air conditioning system are changed based on the air conditioning system control input from the user or temperature information measured from a temperature sensor inside the vehicle, and reflect this in interior lighting control (e.g., adjusting lighting color or intensity to indicate airflow status).

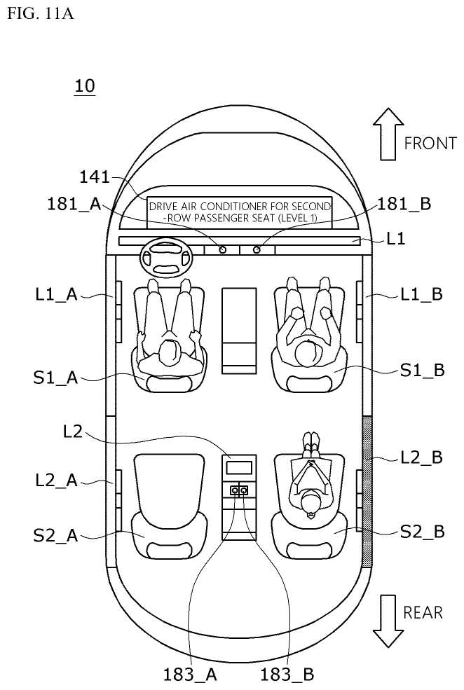

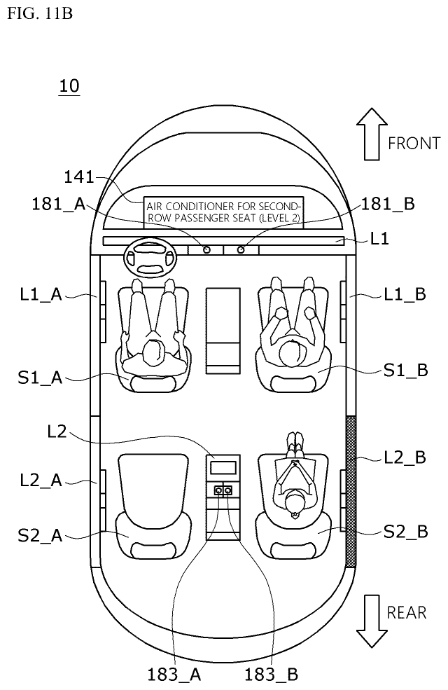

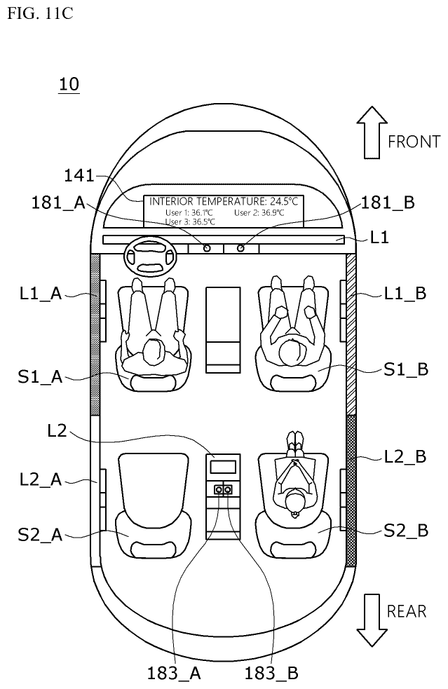

FIG. 9 is a flowchart of a specific operation of controlling an interior lighting device in conjunction with the air conditioning system control event. For the description of FIG. 9, reference will be made to FIGS. 11A and 11B. FIGS. 11A and 11B shows exemplary diagrams of the operation of controlling an interior lighting device in conjunction with the air conditioning system control event according to an example.

The control device 100 may confirm the user boarding information for each seat of the vehicle (S910).

The control device 100 may confirm a user input for controlling the air conditioning system (S920).

For example, the control device 100 may receive a user command input through an operation button or a touch panel located on the air conditioning unit 180 and control the operation of the air conditioner or the heater (e.g., initiating cooling, changing airflow intensity, or selecting seat-specific settings).

Referring to FIG. 11A, a user sitting in the second-row passenger seat side seat S2_B may operate the air conditioner by pushing the fourth air conditioning button 183_B. In this case, information indicating that an air conditioner operation input signal has been received at the second row passenger seat (e.g., for activating or adjusting airflow) may be displayed on the front display 141. In FIG. 11A, a state in which an air conditioner operation input has been received is illustrated as a level 1 output (e.g., low fan speed or minimal cooling).

The control device 100 may confirm a seat adjacent to a location at which the user input has been received (S930).

For example, in FIG. 11A, the control device 100 may recognize the second-row passenger seat side seat S2_B adjacent to the fourth air conditioning button 183_B because the user input has been received through the fourth air conditioning button 183_B (e.g., indicating a localized request for cooling or heating near seat S2_B).

To this end, the control device 100 may retrieve information from the storage unit 120 indicating that each air conditioning button is installed at a specific location (e.g., near the corresponding seat) in the vehicle from the storage unit 120. For example, a specific ID is assigned to the fourth air conditioning button 183_B, and when a signal input through the button is received, the control device 100 may read ID information and confirm that the signal has been originated from the second-row passenger seat side seat S2_B.

The control device 100 may control the interior lighting device corresponding to the seat (S940).

Specifically, the control device 100 may activate the interior lighting device adjacent to the seat where the user input has occurred, so that visual feedback (e.g., a colored glow or pulsing light) can be provided to the user.

For example, in FIG. 11A, the control device 100 may control the lighting unit 170 so that the fourth interior lighting device L2_B corresponding to the second-row passenger seat side seat S2_B outputs light. In this case, the fourth interior lighting device L2_B may output light in the first form (e.g., soft white glow indicating system acknowledgment).

According to an example, the control device 100 may control the output of the interior lighting device differently depending on the output of the air conditioning system.

For example, in FIG. 11B, the user sitting in the second-row passenger seat side seat S2_B may push the fourth air conditioning button 183_B to change an output of the air conditioner. In this case, information indicating that an input signal for requesting the air conditioner output (e.g., level 2 airflow) has been received at the second-row passenger seat may be displayed on the front display 141. Accordingly, the control device 100 may control the lighting unit 170 so that the fourth interior lighting device L2_B corresponding to the second-row passenger seat side seat S2_B outputs light in a changed form (e.g., increased brightness or a different color to indicate the adjusted air flow level). In this case, the fourth interior lighting device L2_B may output light in the second form (e.g., brighter or differently colored light indicating increased airflow).

FIG. 10 is a flowchart of another operation of controlling the interior lighting device in conjunction with the air conditioning system control event. For the description of FIG. 10, reference will be made to FIG. 11C.

The control device 100 may confirm the user boarding information for each seat of the vehicle (S1010) and control the air conditioning system according to user input (e.g., temperature or fan speed adjustment) or automatic control (e.g., based on sensed body temperature or ambient conditions) (S1020).

For example, when a user sitting in the first-row driver seat lowers the air conditioning system temperature of the driver seat, the control device 100 can automatically adjust an output of the air conditioning system around the driver seat so that a temperature and a wind speed set by the user (e.g., 21° C. with low fan speed) are immediately reflected.

Next, the control device 100 may confirm an interior temperature of the vehicle (S1030).

Specifically, the control device 100 may receive interior temperature data from the temperature sensor included in the sensor unit 150 to ascertain a current temperature inside the vehicle (e.g., 24.5° C., as displayed on a central screen).

Next, the control device 100 may confirm a body temperature of the user (S1040).

For example, the control device 100 may detect the body temperature of the user sitting in each seat in a non-contact manner through an infrared sensor or a body temperature detection sensor (e.g., thermal camera or proximity-based heat sensor) included in the sensor unit 150.

For example, the body temperature detection sensor is installed on an upper end or a side surface of each seat inside the vehicle (e.g., near the headrest, armrest, or seatback panel) and is connected to the sensor unit 150 or the control device 100 of the vehicle. This configuration allows body temperature data for the user sitting in each seat to be collected in real time and the temperature data to be transmitted to the control device 100.

Next, the control device 100 may control the interior lighting device based on the interior temperature of the vehicle and the passenger's body temperature (e.g., to provide visual cues reflecting thermal comfort or imbalance) (S1050).

Specifically, the control device 100 may control the output of the interior lighting device so that a difference between the interior temperature of the vehicle 10 and the body temperature of the user is reflected in the output (e.g., color mapping of blue for cooler, red for warmer).

For example, in FIG. 11C, the interior temperature (24.5° C.) of the vehicle 10, based on a current operation of the air conditioning system, is displayed on the front display 141 A body temperature (36.1° C.) of a user (e.g., user 1) sitting in the first-row driver seat S1_A, a body temperature (37.8° C.) of a user (e.g., user 2) sitting in the first-row passenger seat S1_B, and a body temperature (36.5° C.) of a user (e.g., user 3) sitting in the second-row passenger seat side seat S2_B are also displayed on the front display 141.

In this case, since a difference between a current interior temperature of the vehicle 10 and the body temperature of user 1 is the smallest, the control device 100 may confirm the first-row driver seat S1_A in which user 1 is sitting, and cause the first interior lighting device L1_A corresponding to the first-row driver seat S1_A to output light in the first form (e.g., blue to indicate thermal balance).

In addition, since a difference between the current interior temperature of the vehicle 10 and the body temperature of user 3 is the second smallest, the control device 100 may confirm the second-row passenger seat side seat S2_B in which user 3 is sitting, and cause the fourth interior lighting device L2_B corresponding to the second-row passenger seat side seat S2_B to output light in the second form (e.g., green to indicate moderate thermal deviation).

Further, since a difference between the current interior temperature of the vehicle 10 and the body temperature of user 2 is the greatest, the control device 100 may confirm the first-row passenger seat S1_B in which user 2 is sitting, and cause the second interior lighting device L1_B corresponding to the first-row passenger seat S1_B to output light in the third form (e.g., red to indicate a high thermal mismatch).

As described above, the control device 100 may control the interior lighting device differently based on the difference between the body temperature of each user and the interior temperature of the vehicle, thereby providing an effect of delivering intuitive and personalized visual feedback through adaptive lighting responses.

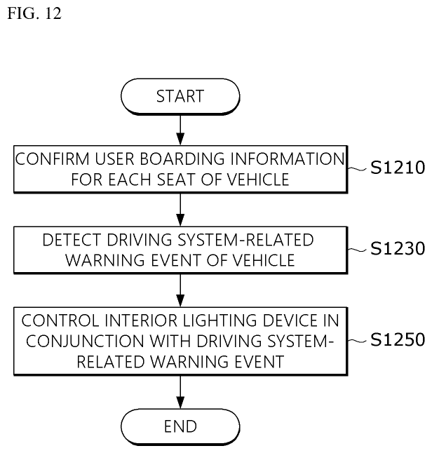

FIG. 12 shows an exemplary operation of controlling the interior lighting device in conjunction with a driving system-related warning event (e.g., lane departure warning, forward collision warning, or blind spot detection alert) according to an example. For the description of FIG. 12, reference will be made to FIG. 13. FIG. 13 shows an exemplary operation of controlling the interior lighting device in conjunction with the driving system-related warning event according to an example.

The control device 100 may confirm the passenger boarding information for each seat of the vehicle 10 (S1210) and detect the driving system-related warning event of the vehicle 10 (S1230).

Specifically, the control device 100 may collect data from various sensors and control devices linked to the driving system of the vehicle 10 to detect a dangerous situation that may occur during driving. For example, the control device 100 may detect vehicles approaching from adjacent lanes (e.g., via blind spot) through a radar sensor, a LIDAR sensor, or a camera module or recognize objects (e.g., pedestrians, cyclists, or debris) approaching from a blind spot to generate a warning event.

For example, referring to FIG. 13, the control device 100 may detect another vehicle 11 approaching from a right lane toward the vehicle 10. In this case, the control device 100 may output a collision detection alarm based on a driving assistance feature or an autonomous driving function of the vehicle 10. This collision detection alarm is a warning according to detection of the external object, and is an example of the driving system-related warning event.

The control device 100 may control an interior lighting device in conjunction with the driving system-related warning event (S1250).

The control device 100 may identify one or more seats located in a direction associated with the warning event, and activate the interior lighting device corresponding to the seat.

For example, referring to FIG. 13, the control device 100 may identify the first-row passenger seat S1_B and the second-row passenger seat side seat S2_B as seats located in a direction of the approaching external object (e.g., the other vehicle 11, speed limit sign, a traffic light, a warning signal, etc.).

The control device 100 may control the lighting unit 170 so that the second interior lighting device L1_B and the fourth interior lighting device L2_B corresponding to the first-row passenger seat S1_B and the second-row passenger seat side seat S2_B, respectively, output light in response to the warning event. In this case, since an accident with the other vehicle 11 may occur, the control device 100 may control the lighting unit 170 so that at least one of the first-row common lighting device L1, the second-row common lighting device L2, and the vehicle common lighting device (not illustrated) additionally outputs light as a visual warning.

The control device 100 may perform support so that the passenger can intuitively recognize a dangerous situation by controlling the lighting around the seat in a direction in which the warning event has occurred according to the direction in which the warning event has occurred. By controlling lighting around the seat(s) located in the direction of the warning event, the control device 100 can visually alert the corresponding passengers to the hazardous situation in an intuitive and localized manner.

According to an example, when an emergency light warning of the vehicle 10 is output or activated, the control device 100 may control the interior lighting device inside the vehicle in coordination with the emergency light warning. Specifically, the control device 100 may control the lighting unit 170 so that the interior lighting devices corresponding to a vehicle center pad (C/PAD) and each seat blink in a designated emergency color (e.g., red) when the emergency light is in operation.

In this case, only the lighting around the seat may be configured to operate in conjunction with the emergency light, based on a position of the passenger on each seat. This allows effective visual feedback to provide a warning to the passenger.

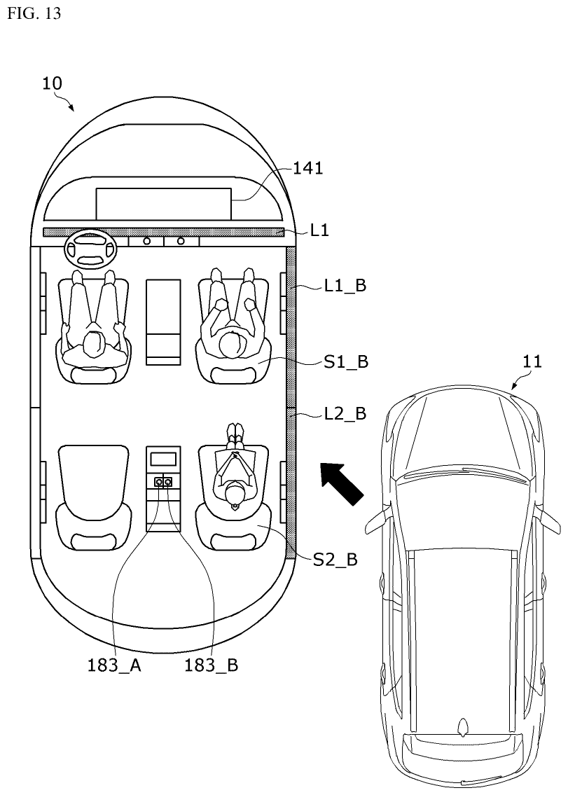

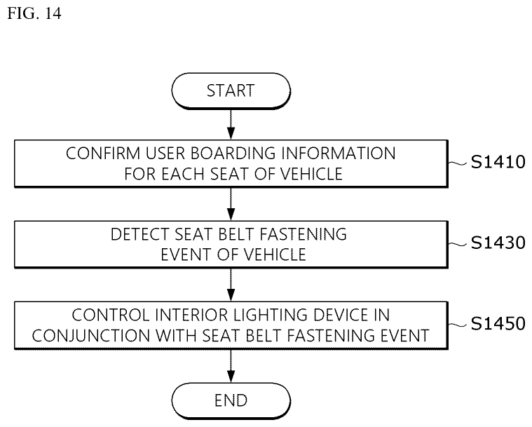

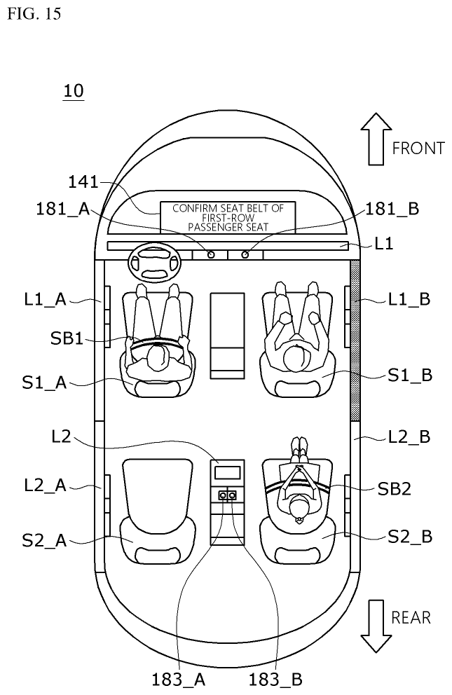

FIG. 14 shows an exemplary operation of controlling the interior lighting device in conjunction with a seat belt fastening event according to an example. For the description of FIG. 14, reference will be made to FIG. 15. FIG. 15 shows an exemplary operation of controlling the interior lighting device in conjunction with the seat belt fastening event according to the example.

The control device 100 may confirm the passenger boarding information for each seat of the vehicle (S1410) and detect the seat belt fastening event of the vehicle (S1430) (e.g., fastening, unfastening, or partial engagement of the seat belt, etc.).

The control device 100 may detect whether the passenger on each seat has fastened the seat belt through a seat belt detection sensor and the seat sensor included in the sensor unit 150 (e.g., pressure sensors, optical sensors, infrared sensors, or capacitive sensors, etc.).

For example, a state in which only users sitting in the first-row driver seat S1_A and the second-row passenger seat side seat S2_B among three passengers have fastened seat belts SB1 and SB2, and the user sitting in the first-row passenger seat S1_B has not fastened a seat belt is illustrated in FIG. 15 (e.g., due to distraction, intentional omission, or improper seating posture, etc.).

In this case, the control device 100 may output information (e.g., a visual icon, a text message, or a flashing indicator, etc.) for requesting the user to fasten a first-row passenger seat belt through the front display 141.

The control device 100 may control the interior lighting device in conjunction with the seat belt fastening event (S1450).

Specifically, the control device 100 may detect a position of the seat where the seat belt is not fastened and control the interior lighting device corresponding to the seat to display a warning (e.g., changing color, blinking pattern, or brightness level, etc.).

For example, in FIG. 15, the control device 100 may control the lighting unit 170 so that the second interior lighting device L1_B outputs light in a warning form (e.g., flashing red, pulsing brightness, or emitting a specific pattern, etc.) because the seat belt for the first-row passenger seat is not currently fastened.

As described above, the control device 100 can visually warn that the seat belt is unfastened through the interior lighting device, thereby inducing the passenger to fasten the seat belt. This can improve the safety in the vehicle and draw the attention of the passenger (e.g., by catching peripheral vision, emphasizing urgency, or reinforcing auditory alerts, etc.).

According to the examples of the drawings described above, the control device 100 can appropriately control the interior lighting device according to the boarding information and various events of the vehicle (e.g., call reception, HVAC adjustment, or safety warnings, etc.), thereby enhancing both the safety and convenience of the passenger.

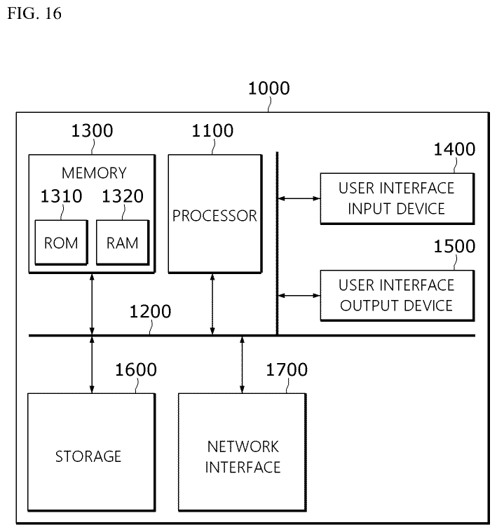

FIG. 16 shows an example computing system (e.g., a computing device of a vehicle or any other apparatus). One or more controllers, processors, etc. described herein, such as one or more components of the vehicle and any other components and devices disclosed herein, may be implemented by or in the computing system as shown in FIG. 16.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an example of the present disclosure, there is provided a vehicle including at least one interior lighting device included in a vehicle; a sensor unit configured to detect the seating of a vehicle user; and a control device configured to confirm boarding information of a user sitting in each seat of the vehicle through the sensor unit, detect an event for controlling the interior lighting device, and control the interior lighting device corresponding to the seat in which the user is sitting based on the boarding information and the event.

In the vehicle according to some examples, the event may include a call event of a user terminal, and the control device may be configured to control the interior lighting device in conjunction with the call event of the user terminal communicatively connected to the vehicle.

In the vehicle according to some examples, the control device may be configured to control the interior lighting device differently according to any one of a call connection waiting state of the user terminal, a call connection state of the user terminal, and a call termination state of the user terminal.

In the vehicle according to some examples, the event may include an event of controlling an air conditioning system of the vehicle, and the control device may be configured to control the interior lighting device corresponding to the seat in conjunction with the control of the air conditioning system.

In the vehicle according to some examples, the control device may be configured to control an output of the interior lighting device differently according to an output of the air conditioning system.

In the vehicle according to some examples, the control device may be configured to confirm a seat adjacent to a location at which a user input for the air conditioning system is received, and control the interior lighting device corresponding to the confirmed seat.

In the vehicle according to some examples, the control device may be configured to confirm an interior temperature of the vehicle according to the control of the air conditioning system, confirm a body temperature of the user of the vehicle, and control the interior lighting device so that a difference between the interior temperature and the body temperature of the user is reflected in an output.

In the vehicle according to some examples, the control device may be configured to control the interior lighting device corresponding to the seat in conjunction with a warning event related to a driving system of the vehicle.

In the vehicle according to some examples, the control device may be configured to confirm a seat in a direction related to an external object when the warning related to the driving system is a warning due to detection of the external object, and control the interior lighting device corresponding to the confirmed seat.

In the vehicle according to some examples, the event may include a warning event related to fastening of a seat belt, and the control device may be configured to control the interior lighting device corresponding to the seat in conjunction with a warning related to fastening of the seat belt of the vehicle.

In the vehicle according to some examples, the control device may be configured to confirm a seat corresponding to the warning related to fastening of the seat belt, and control the interior lighting device corresponding to the confirmed seat.

According to another example of the present disclosure, there is provided a control method including confirming boarding information of a user on each seat of a vehicle; detecting an event for controlling an interior lighting device; and controlling the interior lighting device corresponding to a seat in which a user is sitting based on the boarding information and the event.

In the control method according to some examples, the event may include a call event of a user terminal, and the controlling of the interior lighting device may include controlling the interior lighting device in conjunction with the call event of the user terminal communicatively connected to the vehicle.

In the control method according to some examples, the controlling of the interior lighting device in conjunction with the call event may include controlling the interior lighting device differently according to any one of a call connection waiting state of the user terminal, a call connection state of the user terminal, and a call termination state of the user terminal.

In the control method according to some examples, the event may include an event of controlling an air conditioning system of the vehicle, and the controlling of the interior lighting device may include controlling the interior lighting device corresponding to the seat in conjunction with the control of the air conditioning system.

In the control method according to some examples, the controlling of the interior lighting device corresponding to the seat in conjunction with the control of the air conditioning system may include controlling an output of the interior lighting device differently according to an output of the air conditioning system.

In the control method according to some examples, the controlling of the interior lighting device corresponding to the seat in conjunction with the control of the air conditioning system may include confirming a seat adjacent to a location at which a user input for the air conditioning system is received; and controlling the interior lighting device corresponding to the confirmed seat so that the interior lighting device outputs light.

The control method according to some examples may further include confirming an interior temperature of the vehicle according to the control of the air conditioning system; confirming a body temperature of the user of the vehicle; and controlling the interior lighting device so that a difference between the interior temperature and the body temperature of the user is reflected in an output.

The control method according to some examples may further include controlling the interior lighting device corresponding to the seat in conjunction with a warning event related to a driving system of the vehicle.

In the control method according to some examples, the controlling of the interior lighting device corresponding to the seat in conjunction with the warning event related to the driving system may include confirming a seat in a direction related to an external object when the warning related to the driving system is a warning due to detection of the external object; and controlling the interior lighting device corresponding to the confirmed seat.

In the control method according to some examples, the event may include a warning event related to fastening of a seat belt, and the controlling of the interior lighting device may include controlling the interior lighting device corresponding to the seat in conjunction with a warning related to fastening of the seat belt of the vehicle.

The term ‘˜unit’ used in the example means a software or hardware component such as a field-programmable gate array (FPGA) or an ASIC, and the ‘˜unit’ performs a certain role. However, the ‘˜unit’ is not limited to software or hardware. The ‘˜unit’ may be configured to reside on an addressable storage medium or may be configured to operate one or more processors. Accordingly, for example, the ‘˜unit’ includes components such as software components, object-oriented software components, class components, and task components, processes, functions, attributes, procedures, subroutines, segments of program code, drivers, firmware, microcode, circuits, data, databases, data structures, tables, arrays, and variables. Functions provided in the components and the ‘˜units’ may be combined into a smaller number of components and ‘˜units’ or may be further separated into additional components and ‘˜units’. In addition, the components and ‘˜units’ may be implemented to operate one or more CPUs in a device or a secure multimedia card.

According to an example of the present disclosure, it is possible to maximize an effect of visual feedback through interior lighting and enhance user convenience and safety by controlling the interior lighting device according to the passenger boarding position and various event states in the vehicle.

The effects of the present disclosure are not limited to the effect mentioned above, and other effects not mentioned can be clearly understood by those skilled in the art from the description below.

Although the present disclosure has been described above with reference to preferred examples of the present disclosure, it will be understood by those skilled in the art that various modifications and changes can be made to the present disclosure without departing from the spirit and scope of the present disclosure set forth in the following claims.

What is claimed:

1. A vehicle comprising:
at least one interior lighting device of the vehicle;
a sensor configured to detect seating of a user of the vehicle;
a processor; and
a memory storing at least one instruction that, when executed by the processor communicating with the memory, is configured to cause the vehicle to:
obtain, via the sensor, boarding information about a user sitting in a seat of the vehicle,
detect an event associated with controlling of the at least one interior lighting device,
output a signal indicating the boarding information and indicating the event, and
control, based on the signal, the at least one interior lighting device, wherein the at least one interior lighting device corresponds to the seat in which the user is sitting.

2. The vehicle of claim 1, wherein the event comprises a call event of a user terminal communicatively connected to the vehicle, and wherein the at least one instruction, when executed by the processor communicating with the memory, is configured to cause the vehicle to control, based on the call event, the at least one interior lighting device.

3. The vehicle of claim 2, wherein the at least one instruction, when executed by the processor communicating with the memory, is configured to cause the apparatus to control the at least one interior lighting device differently based on at least one of:
a call connection waiting state of the user terminal,
a call connection state of the user terminal, or
a call termination state of the user terminal.

4. The vehicle of claim 1, wherein the event comprises an event of controlling an air conditioning system of the vehicle, and wherein the at least one instruction, when executed by the processor communicating with the memory, is configured to cause the vehicle to control, based on the controlling of the air conditioning system, the at least one interior lighting device, wherein the at least one interior lighting device is configured to illuminate a location of the seat.

5. The vehicle of claim 4, wherein the at least one instruction, when executed by the processor communicating with the memory, is configured to cause the vehicle to control, based on an output of the air conditioning system, an output of the at least one interior lighting device differently.

6. The vehicle of claim 4, wherein the at least one instruction, when executed by the processor communicating with the memory, is configured to cause the vehicle to:
identify a seat adjacent to a location at which a user input for the controlling of the air conditioning system is received, and
control, based on the identified seat, the at least one interior lighting device.

7. The vehicle of claim 4, wherein the at least one instruction, when executed by the processor communicating with the memory, is configured to cause the vehicle to:
measure, based on the controlling of the air conditioning system, an interior temperature of the vehicle,
measure a body temperature of the user of the vehicle, and
control, based on a temperature difference between the interior temperature and the body temperature of the user, an output of the at least one interior lighting device.

8. The vehicle of claim 1, wherein the at least one instruction, when executed by the processor communicating with the memory, is configured to cause the vehicle to control, based on a warning event associated with a driving of the vehicle, the at least one interior lighting device corresponding to the seat.

9. The vehicle of claim 8, wherein the at least one instruction, when executed by the processor communicating with the memory, is configured to cause the vehicle to:
identify, based on the warning event being associated with a detected external object, a seat in a direction associated with the detected external object, and
control, based on the identified seat, the at least one interior lighting device.

10. The vehicle of claim 1, wherein the event comprises a warning event associated with fastening of a seat belt of the vehicle, and
wherein the at least one instruction, when executed by the processor communicating with the memory, is configured to cause the vehicle to control, based on the warning event associated with fastening of the seat belt, the at least one interior lighting device corresponding to the seat.

11. The vehicle of claim 10, wherein the at least one instruction, when executed by the processor communicating with the memory, is configured to cause the vehicle to:
identify a seat corresponding to the warning event associated with fastening of the seat belt, and
control, based on the identified seat, the at least one interior lighting device, wherein the at least one interior lighting device corresponds to the identified seat.

12. A method performed by a vehicle, the method comprising:
obtaining, via a sensor of the vehicle, boarding information about a user sitting in a seat of the vehicle;
detecting an event associated with controlling an interior lighting device of the vehicle;
outputting a signal indicating the boarding information and indicating the event; and
controlling, based on the signal, the interior lighting device, wherein the interior lighting device corresponds to the seat in which the user is sitting.

13. The method of claim 12, wherein the event comprises a call event of a user terminal communicatively connected to the vehicle, and wherein
the controlling of the interior lighting device comprises controlling, based on the call event, the interior lighting device.

14. The method of claim 13, wherein the controlling of the interior lighting device comprises controlling the interior lighting device differently based on at least one of:
a call connection waiting state of the user terminal,
a call connection state of the user terminal, or
a call termination state of the user terminal.

15. The method of claim 12, wherein the event comprises an event of controlling an air conditioning system of the vehicle, and wherein the controlling of the interior lighting device comprises controlling, based on the event of controlling the air conditioning system of the vehicle, the interior lighting device, wherein the interior lighting device is configured to illuminate a location of the seat.

16. The method of claim 15, wherein the controlling of the interior lighting device comprises controlling, based on an output of the air conditioning system, an output of the interior lighting device differently.

17. The method of claim 15, wherein the controlling of the interior lighting device comprises:
identifying a seat adjacent to a location at which a user input for the controlling of the air conditioning system is received; and
controlling, based on the identified seat, the interior lighting device, wherein the interior lighting device corresponds to the identified seat so that the interior lighting device outputs light over the identified seat.

18. The method of claim 15, further comprising:
measuring, based on the controlling of the air conditioning system, an interior temperature of the vehicle;
measuring a body temperature of the user of the vehicle; and
controlling, based on a temperature difference between the interior temperature and the body temperature of the user, an output of the interior lighting device.

19. A method performed by a vehicle, the method comprising:
obtaining, from a sensor of the vehicle, sensor data indicating a presence of a user within the vehicle;
identifying, based on the obtained sensor data, a seat of the vehicle in which the user is seated;
during an autonomous driving operation of the vehicle, identify an event associated with an object;
output a signal indicating a location of the identified seat and indicating the event; and
controlling, based on the signal, an interior lighting device of the vehicle that is configured to illuminate the location of the identified seat.

20. The method of claim 19, wherein the controlling of the interior lighting device comprises adjusting, based on a type of event detected in the vehicle, a lighting output of the interior lighting device, wherein the lighting output of the interior lighting device indicates a visual indication associated with the object, and wherein the object comprises at least one of an internal object placed in the vehicle or an external object external to the vehicle.
